(19) United States
(12) Patent Application Publication
(10) Pub. No.: US 2026/0145985 A1
(43) Pub. Date: May 28, 2026

(54) SYSTEMS AND METHODS FOR PRODUCING SOOT PREFORMS

(71) Applicant: CORNING INCORPORATED, CORNING, NY (US)

(72) Inventors: Steven Treavis Arndt, Mint Hill, NC (US); Jerrod W. Coning, Carolina Beach, NC (US); Feng Gao, Dover, NJ (US); Nikolaos Pantelis Kladias, Horseheads, NY (US); Kochuparambil Deenamma Vargheese, Horseheads, NY (US)

(21) Appl. No.: 19/394,471

(22) Filed: Nov. 19, 2025

Related U.S. Application Data
(60) Provisional application No. 63/725,726, filed on Nov. 27, 2024.

(51) Int. Cl. C03B 37/018; C03B 37/014

(52) U.S. Cl. CPC C03B 37/01884; C03B 37/01446; C03B 2201/06

(57) ABSTRACT

Described herein includes systems and methods for producing a soot preform. In some embodiments, a lathe system for producing a soot preform may include a housing, an air intake, an exhaust, and an airflow pathway through the housing from the air intake to the exhaust. The lathe system may further include a rotating soot blank disposed inside the housing, and an air blade disposed downstream of the rotating soot blank along the airflow pathway and configured to deliver a cooling airflow toward a surface of the rotating soot blank. In some embodiments, a method of producing a soot preform may include depositing soot on a surface of a rotating soot blank using at least one combustion burner disposed upstream of the rotating soot blank and directing a cooling airflow toward the surface of the rotating soot blank using an air blade disposed downstream of the rotating soot blank.

### CROSS-REFERENCE TO RELATED APPLICATIONS

This application claims the benefit of priority under 35 U.S.C. § 119 of U.S. Provisional Application Serial No. 63/725,726, filed on Nov. 27, 2024, the content of which is relied upon and incorporated herein by reference in its entirety.

### FIELD OF THE DISCLOSURE

This disclosure pertains to optical fiber preforms. More particularly, this disclosure pertains to systems and methods for producing soot preforms.

### BACKGROUND

The process of making high purity fused silica for optical fiber products typically involves multiple stages, all of which can affect the quality of the final product. One of the multiple stages includes depositing glass soot onto a rotating soot blank to form a soot preform. During soot deposition, process conditions may be adjusted, for example, to increase capture efficiency of the raw material. In some instances, such process condition adjustments may include increasing heat flux on the soot blank surface due to, e.g., increased combustion, high temperature flame, etc., to stabilize and contain the soot forming particles. However, the increased heat flux may result in blank distortion, such as bowing. Specifically, the increased heat flux may reduce viscosity of the soot blank, which may cause off-axis rotation of the soot blank, leading to soot blank bowing. Additionally, the off-axis rotation may cause variation in the distance from the burner to the soot blank surface, resulting in azimuthally non-uniform soot capture, which may further result in deposition uniformity and/or concentricity issues. Thus, there is a need for improvements in the soot deposition process.

### SUMMARY

In some embodiments, a lathe system for producing a soot preform may include a housing, an air intake, an exhaust, and an airflow pathway through the housing from the air intake to the exhaust. The lathe system may further include a rotating soot blank disposed inside the housing, and an air blade disposed downstream of the rotating soot blank along the airflow pathway and configured to deliver a cooling airflow toward a surface of the rotating soot blank.

In some embodiments, a method of producing a soot preform may include depositing soot on a surface of a rotating soot blank using at least one combustion burner disposed upstream of the rotating soot blank, and directing a cooling airflow toward the surface of the rotating soot blank using an air blade disposed downstream of the rotating soot blank.

Additional features and advantages will be set forth in the detailed description which follows, and in part will be readily apparent to those skilled in the art from the description or recognized by practicing the embodiments as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

FIG. 1 schematically illustrates a side view of an exemplary lathe system for forming a soot preform.

FIG. 2 schematically illustrates a top view of the exemplary lathe system of FIG. 1.

FIG. 3 is a zoomed view of a portion of the lathe system of FIG. 2.

FIG. 4 schematically illustrates a front view of an exemplary air blade.

FIG. 5 schematically illustrates a cross-sectional view of the air blade of FIG. 4, taken along plane V-V shown in FIG. 4.

FIG. 6 schematically illustrates a cross-sectional view of another exemplary air blade.

FIG. 7 schematically illustrates a front view of another exemplary air blade.

FIG. 8A shows modeled velocity field for the airflow inside a portion of a lathe system without an air blade.

FIG. 8B shows modeled velocity field for the airflow inside a portion of the lathe system of FIG. 1 with an air blade for delivering cooling airflow.

FIG. 9 schemetically illustrates a portion of a lathe system incorporating another exemplary air blade.

FIG. 10A shows modeled temperature contour of a leading half surface of a soot blank without cooling by an air blade.

FIG. 10B shows modeled temperature contour of a leading half surface of a soot blank with cooling by an air blade operating at a cooling airflow velocity of 20 m/s.

FIG. 10C shows modeled temperature contour of a leading half surface of a soot blank with cooling by an air blade operating at a cooling airflow velocity of 40 m/s.

FIG. 11 plots the temperature profiles extracted along a middle line of the leading half surface of each soot blank of FIGS. 10A-10C.

FIG. 12A shows the temperature profiles of soot blanks of 100 mm diameter (i) without cooling by an air blade and (ii) with cooling by an air blade operating at 17 m/s airflow velocity, and the difference therebetween.

FIG. 12B shows the temperature profiles soot blanks of 175 mm diameter (i) without cooling by an air blade and (ii) with cooling by an air blade operating at 17 m/s airflow velocity, and the difference therebetween.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

In this specification, and in the claims, which follow, reference will be made to a number of terms which shall be defined to have the following meanings:

Reference will now be made in detail to illustrative embodiments of the present description.

### Overview

Disclosed herein are systems and methods for cooling the surface of a rotating soot blank during the deposition process, which may involve implementing an air blade downstream of the rotating soot blank. The air blade may be configured to direct cooling airflow towards the surface of the rotating soot blank which may be overloaded with excessive heat. As discussed in more detail below, the air blade may be implemented in any existing system for soot deposition without creating adverse effects on the existing flow conditions. The air blade may provide an effective way of removing heat from the surface of the soot blank during the entire deposition process as the soot blank continues to grow, thereby enabling higher flux processes, e.g., higher deposition rates, without increasing loss due to blank distortion, e.g., bowing, which may otherwise result due to high heat. The air blade described herein may achieve effective cooling over a wide range of cooling airflow velocity and/or flowrates, offering flexibility in control of the processing conditions. Further, the air blade may be implemented as a modular add-on component which may be taken down for regular cleaning and maintenance without interfering with the operation of the deposition system.

### Exemplary Lathe System

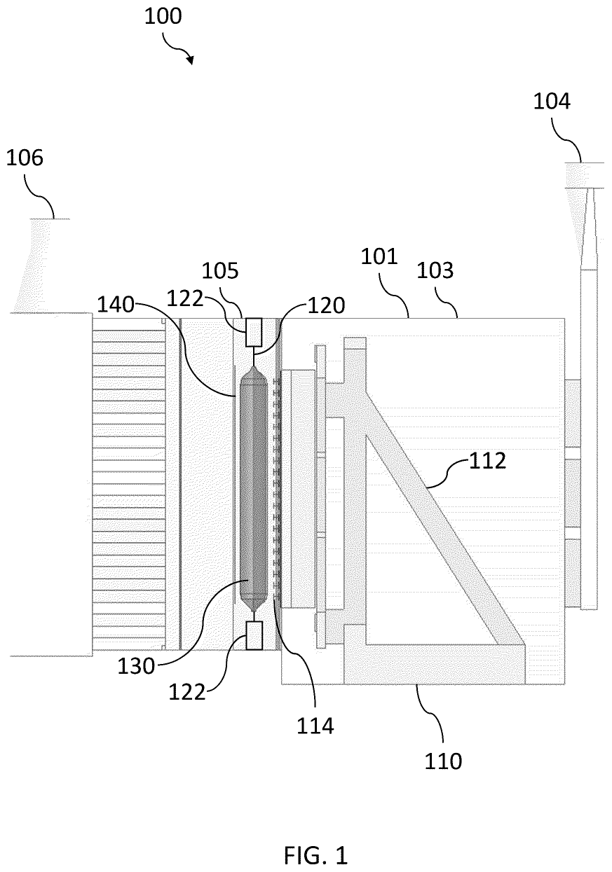

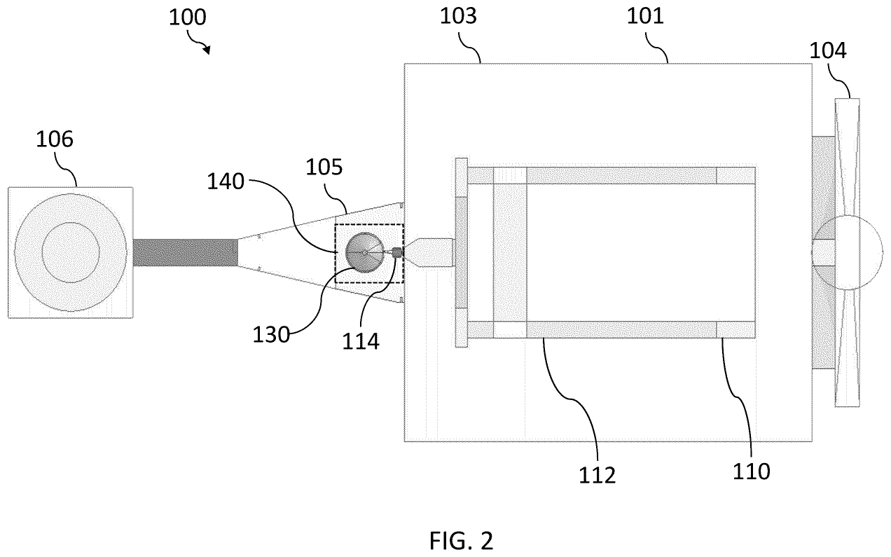

FIGS. 1 and 2 schematically illustrate a side view and a top view, respectively, of an exemplary lathe system 100 for producing a soot preform. The lathe system 100 may include a housing 101. The housing 101 may include spaces or compartments within which various components of the lathe system 100 may be disposed. For example, in some embodiments, the lathe system 100 may include a soot-producing assembly 110 disposed inside a first space 103 the housing 101. In some embodiments, the soot-producing assembly 110 may include a manifold 112 configured for supplying glass precursors, fuel, and/or oxygen and a plurality of burners 114 configured for producing silica-containing soot via combustion of the glass precursors, fuel, and/or oxygen. The burners 114 of the soot-producing assembly 110 may be configured such that the produced silica-containing soot may flow from the burners 114 toward a rotating rod 120 and may be deposited thereon to form a soot blank 130. In some embodiments, the soot-producing assembly 110 may include greater than or equal to (i.e., ≥) two, five, ten, fifteen, twenty, or more vertically arranged burners 114. The number of burners 114 and/or the vertical spacing between adjacent burners 114 may be configured such that uniform deposition of silica soot onto the rotating rod 120 and/or consistent diameter of the soot blank 130 may be achieved. In some embodiments, the rotating rod 120 and the soot blank 130 may be disposed inside a second space 105 of the housing 101. In some embodiments, the rotating rod 120 may include a bait rod or a glass core cane. In some embodiments, a pair of support clamps 122 may support the rotating rod 120 in a vertical position while allowing for rotation of the rotating rod 120 and the soot blank 130.

### Airflow Pathway Inside Housing

In some embodiments, the lathe system 100 may further include an air intake 104 and an exhaust 106 and define an airflow pathway from the air intake 104 to the exhaust 106. Positions along the airflow pathway that are closer to the air intake 104 are said herein to be upstream of positions along the airflow pathway that are further away from the inlet 104; similarly, positions along the airflow pathway that are closer to the exhaust 106 are said herein to be downstream of positions along the airflow pathway that are further way from the exhaust 106. In some embodiments, the air intake 104 and the exhaust 106 may be configured such that air inside the housing 101 may generally flow horizontally from the soot-producing assembly 110 towards the rotating soot blank 130 then to the exhaust 106. Thus, the soot-producing assembly 110 may be said to be upstream of the rotating soot blank 130, and the rotating soot blank 130 downstream of the soot-producing assembly. In some embodiments, the airflow from the air intake 104 to the exhaust 106 within the housing 101 may be regulated to cool the various components disposed inside the housing 101 and to remove contaminants (including soot particles not deposited on the rotating soot blank 130) from the housing 101.

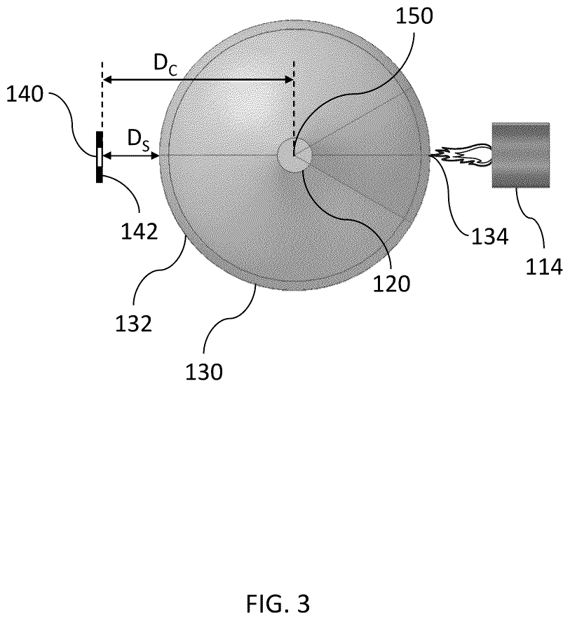

In some embodiments, the lathe system 100 may further include an air blade 140 positioned downstream of the rotating soot blank 130. FIG. 3 is a zoomed view of a portion (marked by dash lines) of the lathe system 100 of FIG. 2, schematically illustrating the air blade 140, the soot blank 130, and the burners 114. As will be discussed in more detail below, the air blade 140 may be configured to further remove excessive heat from the surface of the soot blank 130 by flowing high velocity cooling air, e.g., air at or below room temperature or at or below 25° C., to the rotating soot blank 130. In some embodiments, an air compressor may be coupled to the air blade 140 for supplying the cooling airflow to the air blade 140.

While the burners 114, the rotating rod 120, the soot blank 130, and the air blade 140 are each shown in a vertical orientation and a generally horizonal airflow pathway inside the housing 101 is described with reference to FIGS. 1, 2, and 3, it should be noted that in some embodiments, the burners 114, the rotating rod 120, the soot blank 130, and the air blade 140 may be oriented horizontally and the airflow pathway inside the housing 101 may be generally upward or downward depending on the particular implementations. For example, the burners 114 may be disposed below the rotating soot blank 130 and the air blade 140 may be disposed above the soot blank 130 with each oriented horizontally, and the airflow may be regulated to facilitate deposition of the silica-containing soot onto the rotating soot blank 130, removal of contaminant away from the soot blank 130, and/or cooling of the various components.

### Air Blade with Slot

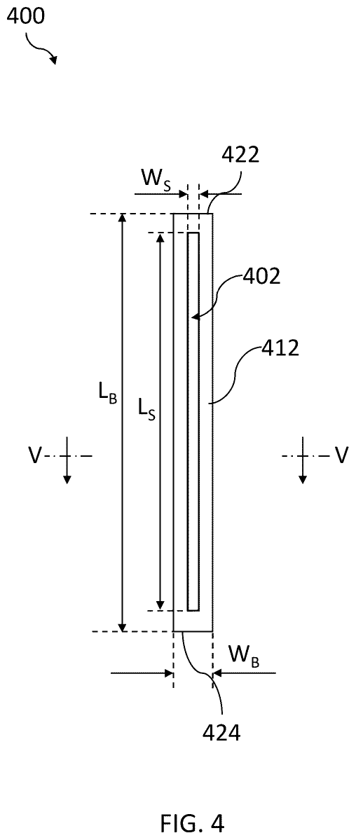

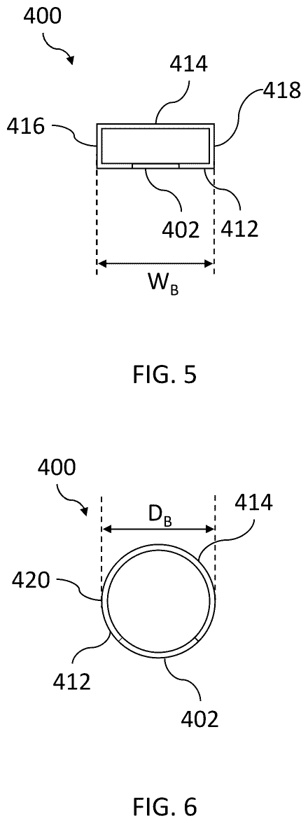

Referring to FIG. 4, a front view of an exemplary air blade 400 is schematically shown. FIG. 5 is a cross-sectional view of the air blade 400, taken along plane V-V shown in FIG. 4. The air blade 400 may be used as the air blade 140 in the lathe system 100.

### Blade Profile

As shown, the air blade 400 may include a leading wall 412 configured to face the rotating soot blank 130, a trailing wall 414 opposite the leading wall 412, side walls 416, 418 extending between the leading wall 412 and the trailing wall 414, and top and bottom walls 422, 424 between which the leading wall 412, the trailing wall 414, and side walls 416, 418 may extend.

A width W_{B} of the air blade 400, defined as the distance between the exterior surfaces of the side walls 416, 418, may be greater than or equal to (i.e., ≥) 25 mm and less than or equal to (i.e., ≤) 75 mm—including all sub-ranges or values therebetween. For example, in some embodiments, the width W_{B} of the air blade 400 may be ≥25 mm and ≤75 mm, ≥25 mm and ≤50 mm, or ≥50 mm and ≤75 mm. In some embodiments, the width W_{B} of the air blade 400 may be greater than or equal to (i.e., ≥) 25 mm, ≥30 mm, ≥35 mm, ≥40 mm, ≥45 mm, ≥50 mm, ≥55 mm, ≥60 mm, ≥65 mm, ≥70 mm, or greater. In some embodiments, the width W_{B} of the air blade 400 may be less than or equal to (i.e., ≤) 75 mm, ≤70 mm, ≤65 mm, ≤60 mm, ≤55 mm, ≤50 mm, ≤45 mm, ≤40 mm, ≤35 mm, ≤30 mm, or less. The values of the width W_{B} of the air blade 400 described herein may limit any build-up of contaminants on the surface of the air blade 400.

While a rectangular cross-sectional profile of the air blade 400 is shown in FIG. 5, the cross section of the air blade 400 may include other shapes, such as triangular, square, other polygonal shapes, circular, oval, etc. In the embodiments where the air blade 400 may include a circular cross section, such as shown in FIG. 6, the leading wall 412 and the trailing wall 414 may be the leading half and the trailing half, respectively, of the circular wall 420 of the air blade 400. In the embodiment shown in FIG. 6, the width W_{B} of the air blade 400 may correspond to an outer diameter D_{B} of the air blade 400. In some embodiments, the outer diameter D_{B} of the air blade 400 may be greater than or equal to (i.e., ≥) 25 mm and less than or equal to (i.e., ≤) 75 mm—including all sub-ranges or values therebetween. For example, in some embodiments, the outer diameter D_{B} of the air blade 400 may be ≥25 mm and ≤75 mm, ≥25 mm and ≤50 mm, or ≥50 mm and ≤75 mm. In some embodiments, the outer diameter D_{B} of the air blade 400 may be greater than or equal to (i.e., ≥) 25 mm, ≥30 mm, ≥35 mm, ≥40 mm, ≥45 mm, ≥50 mm, ≥55 mm, ≥60 mm, ≥65 mm, ≥70 mm, or greater. In some embodiments, the outer diameter D_{B} of the air blade 400 may be less than or equal to (i.e., ≤) 75 mm, ≤70 mm, ≤65 mm, ≤60 mm, ≤55 mm, ≤50 mm, ≤45 mm, ≤40 mm, ≤35 mm, ≤30 mm, or less. The values of the outer diameter D_{B} of the air blade 400 described herein may limit any build-up of contaminants on the surface of the air blade 400.

In some embodiments, the air blade 400 may include a consistent or substantially consistent cross section throughout the entire length L_{B} of the air blade 400 or a major portion, e.g., greater than or equal to (i.e., ≥) 50%, ≥60%, ≥70%, ≥80%, ≥90%, ≥95%, ≥99% of the length L_{B} of the air blade 400. The length L_{B} of the air blade 400 is defined as the distance between the exterior surfaces of the top and bottom walls 422, 424 of the air blade 400.

### Slot Configuration

In some embodiments, the air blade 400 may include at least one air outlet, more specifically, a slot 402 disposed in the leading wall 412 of the air blade 400. The slot 402 may have a length L_{S} and a width W_{S} less than and transverse to the length L_{S}. The slot 402 may be configured to face the rotating soot blank 130 and to provide cooling airflow towards the rotating soot blank 130. While a single continuous slot 402 is shown in FIG. 4, in some embodiments, the air blade 400 may include multiple segments of air slots 402 arranged along the length of the air blade 400.

### Slot Length L_{S}

In some embodiments, the length L_{S} of the slot 402 may be configured to be similar to the length of the soot blank 130 so as to ensure the airflow from the air blade 400 may cover the entire soot blank 130. In some embodiments, the length L_{S} of the slot 402 may be greater than or equal to (i.e., ≥) 1.5 m and less than or equal to (i.e., ≤) 3 m—including all sub-ranges or values therebetween. For example, in some embodiments, the length L_{S} of the slot 402 may be ≥1.5 m and ≤3 m, ≥1.5 m and ≤2.5 m, ≥1.5 m and ≤2 m, ≥2 m and ≤3 m, ≥2 m and ≤2.5 m, or ≥2.5 m and ≤3 m. In some embodiments, the length L_{S} of the slot 402 may be greater than or equal to (i.e., ≥) 1.5 m, ≥1.7 m, ≥1.9 m, ≥2.1 m, ≥2.3 m, ≥2.5 m, ≥2.7 m, ≥2.9 m, or greater. In some embodiments, the length L_{S} of the slot 402 may be less than or equal to (i.e., ≤) 3 m, ≤2.8 m, ≤2.6 m, ≤2.4 m, ≤2.2 m, ≤2 m, ≤1.8 m, ≤1.6 m, or less.

In some embodiments, a ratio of the length L_{S} of the slot 402 of the air blade 400 to the length L_{B} of the air blade 400 may be greater than or equal to (i.e., ≥) 0.5 and less than or equal to (i.e., ≤) 0.99—including all sub-ranges or values therebetween. For example, in some embodiments, the ratio of the length L_{S} of the slot 402 of the air blade 400 to the length L_{B} of the air blade 400 may be ≥0.5 and ≤0.99, ≥0.5 and ≤0.9, ≥0.5 and ≤0.8, ≥0.5 and ≤0.7, ≥0.5 and ≤0.6, ≥0.6 and ≤0.99, ≥0.6 and ≤0.9, ≥0.6 and ≤0.8, ≥0.6 and ≤0.7, ≥0.7 and ≤0.99, ≥0.7 and ≤0.9, ≥0.7 and ≤0.8, ≥0.8 and ≤0.99, ≥0.8 and ≤0.9, or ≥0.9 and ≤0.99.

In some embodiments, the ratio of the length L_{S} of the slot 402 of the air blade 400 to the length L_{B} of the air blade 400 may be greater than or equal to (i.e., ≥) 0.5, ≥0.55, ≥0.6, ≥0.65, ≥0.7, ≥0.75, ≥0.8, ≥0.85, ≥0.9, ≥0.95, or greater. In some embodiments, the ratio of the length L_{S} of the slot 402 of the air blade 400 to the length L_{B} of the air blade 400 may be less than or equal to (i.e., ≤) 0.99, ≤0.95, ≤0.9, ≤0.85, ≤0.8, ≤0.75, ≤0.7, ≤0.65, ≤0.6, ≤0.55, or less.

### Slot Width W_{S}

In some embodiments, the width W_{S} of the slot 402 may be greater than or equal to (i.e., ≥) 0.05 mm and less than or equal to (i.e., ≤) 1.5 mm—including all sub-ranges or values therebetween. For example, in some embodiments, the width W_{S} of the slot 402 may be ≥0.05 mm and ≤1.5 mm, ≥0.05 mm and ≤1 mm, ≥0.05 mm and ≤0.5 mm, ≥0.05 mm and ≤0.1 mm, ≥0.1 mm and ≤1.5 mm, ≥0.1 mm and ≤1 mm, ≥0.1 mm and ≤0.5 mm, ≥0.5 mm and ≤1.5 mm, ≥0.5 mm and ≤1 mm, or ≥1 mm and ≤1.5 mm. In some embodiments, the width W_{S} of the slot 402 may be greater than or equal to (i.e., ≥) 0.05 mm, ≥0.1 mm, ≥0.2 mm, ≥0.3 mm, ≥0.4 mm, ≥0.5 mm, ≥0.6 mm, ≥0.7 mm, ≥0.8 mm, ≥0.9 mm, ≥1 mm, ≥1.1 mm, ≥1.2 mm, ≥1.3 mm, ≥1.4 mm, or greater. In some embodiments, the width W_{S} of the slot 402 may be less than or equal to (i.e., ≤) 1.5 mm, ≤1.4 mm, ≤1.3 mm, ≤1.2 mm, ≤1.1 mm, ≤1 mm, ≤0.9 mm, ≤0.8 mm, ≤0.7 mm, ≤0.6 mm, ≤0.5 mm, ≤0.4 mm, ≤0.3 mm, ≤0.2 mm, ≤0.1 mm, or less. The values of the width W_{S} of the slot 402 described herein may allow for sufficient airflow rate while also achieving high airflow velocities for the cooling airflow to reach the surface 132 of the rotating soot blank 130 to achieve effective cooling. In some embodiments, the width W_{S} of the slot 402 may be consistent or substantially consistent throughout the entire length L_{S} of the slot 402, or consistent or substantially consistent throughout a major portion, e.g., greater than or equal to (i.e., ≥) 50%, ≥60%, ≥70%, ≥80%, ≥90%, ≥95%, ≥99%, of the length L_{S} of the slot 402.

### Air Blade with Nozzles

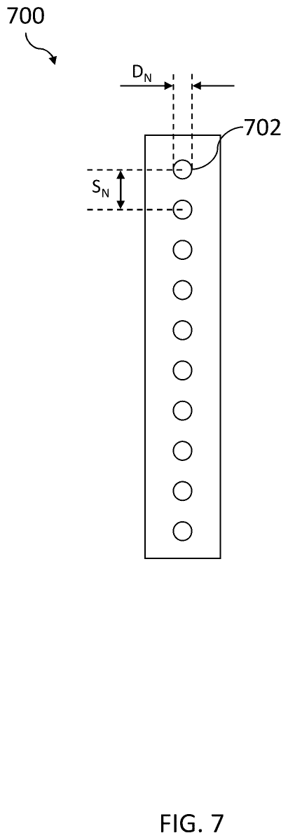

FIG. 7 schematically illustrates another exemplary embodiment of an air blade 700. The air blade 700 may be used as the air blade 140 in the lathe system 100. The air blade 700 may be the same as or similar to the air blade 400 in many aspects. For example, the cross-sectional profile of the air blade 700 may be similar to the cross-sectional profile of the air blade 400, the shape, width, depth, or diameter of which as described above with reference to FIGS. 5 and 6 are thus equally applicable to the air blade 700 and not repeated.

### Nozzle Configuration

In some embodiments, instead of the slot 402, the air blade 700 may include at least one air outlet, more specifically, a plurality of nozzles 702 configured to face the rotating soot blank 130 and to provide high velocity cooling airflow towards the rotating soot blank 130. In some embodiments, a manifold may be utilized to supply the cooling airflow to individual nozzles 702. In some embodiments, the number of the nozzles 702 may be greater than or equal to the number of burners 114 for depositing silica-containing soot onto the rotating soot blank 130 so as to achieve effective and uniform cooling of the rotating soot blank 130.

### Nozzle Opening Diameter

In some embodiments, the opening of each of the nozzles 702 may include a diameter D_{N} greater than or equal to (i.e., ≥) 1 mm and less than or equal to (i.e., ≤) 20 mm—including all sub-ranges or values therebetween. For example, in some embodiments, the diameter D_{N} of the opening of each of the nozzles 702 may be ≥1 mm and ≤20 mm, ≥1 mm and ≤15 mm, ≥1 mm and ≤10 mm, ≥1 mm and ≤5 mm, ≥5 mm and ≤20 mm, ≥5 mm and ≤15 mm, ≥5 mm and ≤10 mm, ≥10 mm and ≤20 mm, ≥10 mm and ≤15 mm, or ≥15 mm and ≤20 mm. In some embodiments, the diameter D_{N} of the opening of each of the nozzles 702 may be greater than or equal to (i.e., ≥) 1 mm, ≥3 mm, ≥5 mm, ≥7 mm, ≥9 mm, ≥11 mm, ≥13 mm, ≥15 mm, ≥17 mm, ≥19 mm, or greater. In some embodiments, the diameter D_{N} of the opening of each of the nozzles 702 may be less than or equal to (i.e., ≤) 20 mm, ≤18 mm, ≤16 mm, ≤14 mm, ≤12 mm, ≤10 mm, ≤8 mm, ≤6 mm, ≤4 mm, ≤2 mm, or less. The values of the diameter D_{N} of the nozzles 702 described herein may allow for sufficient airflow rate while also achieving high airflow velocities for the cooling airflow to reach the surface 132 of the rotating soot blank 130 to achieve effective cooling.

### Nozzle Spacing

In some embodiments, the nozzles 702 may be spaced apart from adjacent nozzles 702 at an equal distance so as to distribute the cooling airflow uniformly along the entire rotating soot blank 130. In some embodiments, the spacing S_{N} between adjacent nozzles 702, defined as the distance between the centers of the openings of adjacent nozzles 702, may be greater than or equal to (i.e., ≥) 2 mm and less than or equal to (i.e., ≤) 100 mm—including all sub-ranges or values therebetween. For example, in some embodiments, the spacing S_{N} between adjacent nozzles 702 may be ≥2 mm and ≤100 mm, ≥2 mm and ≤75 mm, ≥2 mm and ≤50 mm, ≥2 mm and ≤25 mm, ≥25 mm and ≤100 mm, ≥25 mm and ≤75 mm, ≥25 mm and ≤50 mm, ≥50 mm and ≤100 mm, ≥50 mm and ≤75 mm, or ≥75 mm and ≤100 mm. In some embodiments, the spacing S_{N} between adjacent nozzles 702 may be greater than or equal to (i.e., ≥) 2 mm, ≥5 mm, ≥10 mm, ≥15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In some embodiments, the spacing S_{N} between adjacent nozzles 702 may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, ≤15 mm, ≤10 mm, ≤5 mm, or less. The values of the spacing S_{N} between adjacent nozzles 702 described herein may limit interaction between airflows from adjacent nozzles 702 so that the airflow from each nozzle 702 may not be disturbed by the airflows from adjacent nozzles 702. Additionally, the values of the spacing S_{N} between adjacent nozzles 702 described herein may allow for ease of manufacturing and/or structural reliability of the nozzles 702 of the air blade 700.

### Nozzle Diameter to Spacing Ratio

In some embodiments, a ratio of the spacing S_{N} between adjacent nozzles 702 to the diameter D_{N} of the nozzles 702 may be greater than or equal to (i.e., >) 2:1 and less than or equal to (i.e., ≤) 5:1—including all sub-ranges or values therebetween. For example, in some embodiments, the ratio of the spacing S_{N} between adjacent nozzles 702 to the diameter D_{N} of the nozzles 702 may be ≥2:1 and ≤5:1, ≥2:1 and ≤4:1 ≥2:1 and ≤3:1, ≥3:1 and ≤5:1, ≥3:1 and ≤4:1, or ≥4:1 and ≤5:1. In some embodiments, the ratio of the spacing S_{N} between adjacent nozzles 702 to the diameter D_{N} of the nozzles 702 may be greater than or equal to (i.e., ≥) 2:1, ≥2.25:1, ≥2.5:1,≥2.75:1, ≥3:1, ≥3.25:1, ≥3.5:1, ≥3.75:1, ≥4:1, ≥4.25:1, ≥4.5:1, ≥4.75:1, or greater. In some embodiments, the ratio of the spacing S_{N} between adjacent nozzles 702 to the diameter D_{N} of the nozzles 702 may be less than or equal to (i.e., ≤) 5:1, ≤4.75:1, ≤4.5:1, ≤4.25:1, ≤4:1, ≤3.75:1, ≤3.5:1, ≤3.25:1, ≤3:1, ≤2.75:1, ≤2.5:1, ≤2.25:1, or less.

### Integration of Air Blade into Lathe System

As discussed above, the air intake 104 and the exhaust 106 of the lathe system 100 may be configured to provide airflow to cool the various components inside the housing 101 and/or to remove contaminants from the housing 101 of the lathe system 100. The structure and/or dimensions of the various embodiments of the air blade 140 described herein, as well as the configuration and/or operation of the air outlet (e.g., slot 402, nozzles 702, etc.) of the air blade 140, may be configured such that the airflow inside the housing 101 as regulated at least in part by the air intake 104 and the exhaust 106 may not be altered significantly by the presence and/or operation of the air blade 140. This way, the various embodiments of the air blade 140 described herein may be integrated into any lathe system that may not include such air blade 140 without adversely affecting the existing airflow and operation of the system while providing additional cooling for the soot blank 130.

### Blade-Blank Distance

Referring back to FIG. 3, when the air blade 140 may be integrated into the lathe system 100, a distance D_{C} between the leading surface 142 of the air blade 140 facing the rotating soot blank 130 and the centerline 150 of the rotating soot blank 130, which may correspond to the centerline 150 of the rotating rod 120, may be greater than or equal to (i.e., ≥) 185 mm and less than or equal to (i.e., ≤) 370 mm—including all sub-ranges or values therebetween. For example, in some embodiments, distance D_{C} between the leading surface 142 of the air blade 140 facing the rotating soot blank 130 and the centerline 150 of the rotating soot blank 130 may be ≥185 mm and ≤370 mm, ≥185 mm and ≤320 mm, ≥185 mm and ≤270 mm, ≥185 mm and ≤220 mm, ≥220 mm and ≤370 mm, ≥220 mm and ≤320 mm, ≥220 mm and ≤270 mm, ≥270 mm and ≤370 mm, ≥270 mm and ≤320 mm, ≥270 mm and ≤270 mm, or ≥320 mm and ≤370 mm.

In some embodiments, the distance D_{C} between the leading surface 142 of the air blade 140 facing the rotating soot blank 130 and the centerline 150 of the rotating soot blank 130 may be greater than or equal to (i.e., ≥) 185 mm, ≥195 mm, ≥205 mm, ≥215 mm, ≥225 mm, ≥235 mm, ≥245 mm, ≥255 mm, ≥265 mm, ≥275 mm, ≥285 mm, ≥295 mm, ≥305 mm, ≥315 mm, ≥325 mm, ≥335 mm, ≥345 mm, ≥355 mm, ≥365 mm, or greater. In some embodiments, the distance D_{C} between the leading surface 142 of the air blade 140 facing the rotating soot blank 130 and the centerline 150 of the rotating soot blank 130 may be less than or equal to (i.e., ≤) 370 mm, ≤360 mm, ≤350 mm, ≤340 mm, ≤330 mm, ≤320 mm, ≤310 mm, ≤300 mm, ≤290 mm, ≤280 mm, ≤270 mm, ≤260 mm, ≤250 mm, ≤240 mm, ≤230 mm, ≤220 mm, ≤210 mm, ≤200 mm, ≤190 mm, or less.

A distance D_{S} between the leading surface 142 of the air blade 140 and the surface 132 of the soot blank 130 may be greater than or equal to (i.e., ≥) 60 mm and less than or equal to (i.e., ≤) 240 mm—including all sub-ranges or values therebetween. For example, in some embodiments, the distance D_{S} between the leading surface 142 of the air blade 140 and the surface 132 of the soot blank 130 may be ≥60 mm and ≤240 mm, ≥60 mm and ≤180 mm, ≥60 mm and ≤120 mm, ≥120 mm and ≤240 mm, ≥120 mm and ≤180 mm, or ≥180 mm and ≤240 mm.

In some embodiments, the distance D_{S} between the leading surface 142 of the air blade 140 and the surface 132 of the soot blank 130 may be greater than or equal to (i.e., ≥) 60 mm, ≥70 mm, ≥80 mm, ≥90 mm, ≥100 mm, ≥110 mm, ≥120 mm, ≥130 mm, ≥140 mm, ≥150 mm, ≥160 mm, ≥170 mm, ≥180 mm, ≥190 mm, ≥200 mm, ≥210 mm, ≥220 mm, ≥230 mm, or greater. In some embodiments, the distance D_{S} between the leading surface 142 of the air blade 140 and the surface 132 of the soot blank 130 may be less than or equal to (i.e., ≤) 240 mm, ≤230 mm, ≤220 mm, ≤210 mm, ≤200 mm, ≤190 mm, ≤180 mm, ≤170 mm, ≤160 mm, ≤150 mm, ≤140 mm, ≤130 mm, ≤120 mm, ≤110 mm, ≤100 mm, ≤90 mm, ≤80 mm, ≤70 mm, or less.

The distance D_{C} between the leading surface 142 of the air blade 140 and the centerline 150 of the rotating soot blank 130 and/or the distance D_{S} between the leading surface 142 of the air blade 140 and the surface 132 of the soot blank 130 may be configured such that effective heat removal from the surface 132 of the soot blank 130 may be achieved by the cooling airflow from the air blade 140 without adversely affecting the existing airflow from the air intake 104 to the exhaust 106 or causing contaminants to flow back onto the surface 132 of the soot blank 130.

In some embodiments, the distance D_{C} between the leading surface 142 of the air blade 140 and the centerline 150 of the rotating soot blank 130 may remain constant during the deposition of the silica-containing soot onto the rotating soot blank 130. Accordingly, the distance D_{S} between the leading surface 142 of the air blade 140 and the surface 132 of the soot blank 130 may gradually decrease throughout the deposition process. In some embodiments, the air blade 140 may be configured to move relative to the rotating soot blank 130. For example, in some embodiments, the air blade 140 may be movable relative to the soot blank 130 such that the distance D_{S} between the leading surface 142 of the air blade 140 and the surface 132 of the soot blank 130 may remain constant during the deposition process, while the distance D_{C} between the leading surface 142 of the air blade 140 and the centerline 150 of the rotating soot blank 130 may gradually increase. In some embodiments, both the distance D_{S} between the leading surface 142 of the air blade 140 and the surface 132 of the soot blank 130 and the distance D_{C} between the leading surface 142 of the air blade 140 and the centerline 150 of the rotating soot blank 130 may be adjusted throughout the deposition process.

Flowrate from Air Blade

In some embodiments, the flowrate of the cooling airflow from the air blade 140, e.g., the flowrate from the slot 402 of the air blade 400 or the flowrate from all of the nozzles 702 of the air blade 700, may be greater than or equal to (i.e., ≥) 0.002 m³/s (or 4.2 ft³/min) and less than or equal to (i.e., ≤) 0.004 m³/s (or 8.5 ft³/min)—including all sub-ranges or values therebetween. For example, in some embodiments, the flowrate of the air blade 140 may be ≥0.002 m³/s and ≤0.004 m³/s, ≥0.002 m³/s and ≤0.0035 m³/s, ≥0.002 m³/s and ≤0.003 m³/s, ≥0.002 m³/s and ≤0.0025 m³/s, ≥0.0025 m³/s and ≤0.004 m³/s, ≥0.0025 m³/s and ≤0.0035 m³/s, ≥0.0025 m³/s and ≤0.003 m³/s, ≥0.003 m³/s and ≤0.004 m³/s, ≥0.003 m³/s and ≤0.0035 m³/s, or ≥0.0035 m³/s and ≤0.004 m³/s. In some embodiments, the flowrate of the air blade 140 may be greater than or equal to (i.e., ≥) 0.002 m³/s, ≥0.0025 m³/s, ≥0.003 m³/s, ≥0.0035 m³/s, or greater. In some embodiments, the flowrate of the air blade 140 may be less than or equal to (i.e., ≤) 0.004 m³/s, ≤0.0035 m³/s, ≤0.003 m³/s, ≤0.0025 m³/s, or less. The various flowrates described herein may balance the competing metrics for providing sufficient cooling effect to the surface of the rotating soot blank 130 without increasing the risk of bringing contaminants from downstream back up to the surface 132 of the rotating soot blank 130.

Airflow Velocity from Air Blade

In some embodiments, the airflow velocity from the air blade 140 toward the soot blank 130 may be greater than or equal to 0.44 m/s and less than or equal to (i.e., ≤) 53 m/s—including all sub-ranges or values therebetween. For example, in some embodiments, the airflow velocity from the air blade 140 toward the soot blank 130 may be ≥0.44 m/s and ≤53 m/s, ≥0.44 m/s and ≤40 m/s, ≥0.44 m/s and ≤25 m/s, ≥0.44 m/s and ≤10 m/s, ≥10 m/s and ≤53 m/s, ≥10 m/s and ≤40 m/s, ≥10 m/s and ≤25 m/s, ≥25 m/s and ≤53 m/s, ≥25 m/s and ≤40 m/s, or ≥40 m/s and ≤53 m/s. In some embodiments, the airflow velocity from the air blade 140 toward the soot blank 130 may be ≥0.44 m/s, ≥5 m/s, ≥10 m/s, ≥15 m/s, ≥20 m/s, ≥25 m/s, ≥30 m/s, ≥35 m/s, ≥40 m/s, ≥45 m/s, ≥50 m/s, or greater. In some embodiments, the airflow velocity from the air blade 140 toward the soot blank 130 may be ≤53 m/s, ≤50 m/s, ≤45 m/s, ≤40 m/s, ≤35 m/s, ≤30 m/s, ≤25 m/s, ≤20 m/s, ≤15 m/s, ≤10 m/s, ≤5 m/s, or less. The various airflow velocities described herein may allow for effective cooling of the surface of the rotating soot blank 130 without causing significant contaminant backflow toward the surface of the rotating soot blank 130.

### Effect on Velocity Field

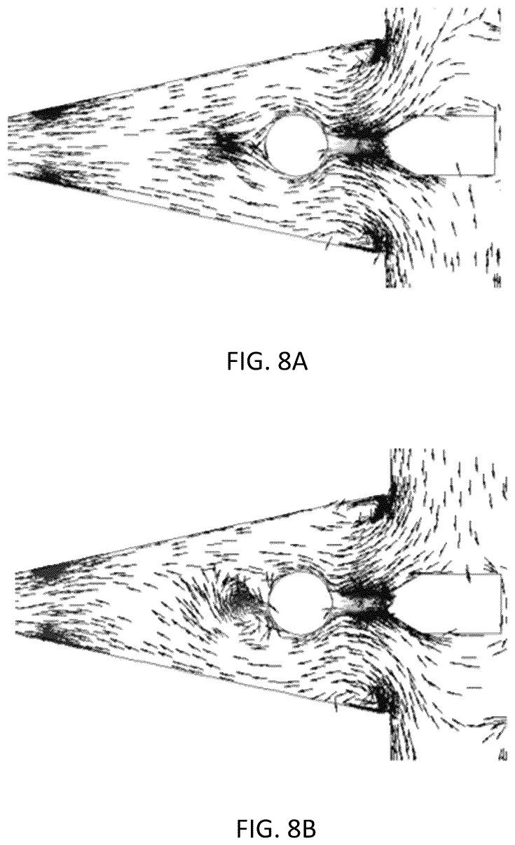

FIG. 8A shows the modeled velocity field for the airflow inside the second space 105 and a portion of the first space 103 of the lathe system 100 without the air blade 140. FIG. 8B shows the modeled velocity field for the airflow inside the same spaces as FIG. 8A with the air blade 140 positioned downstream of the rotating soot blank 130 and delivering cooling airflow towards the surface 132 of the rotating soot blank 130. For the modeling, Computational Fluid Dynamics (CFD) is used, and the following parameters are assumed: the distance D_{C} between the leading surface 142 of the air blade 140 and the centerline 150 of the rotating soot blank 130 is 185 mm; the distance D_{S} between the leading surface 142 of the air blade 140 and the surface 132 of the soot blank 130 is 60 mm; airflow velocity from the air blade 140 to the soot blank 130 is 20 m/s; and the flowrate of the air blade 140 is 0.002 m³/s.

As shown, when the air blade 140 may be incorporated into the lathe system 100 and operating, the velocity field around the soot blank 130 may not be affected significantly, with the velocity pattern and velocity magnitude being similar prior to and after incorporation of the air blade 140. For example, the flow boundary near the flame surface remains substantially unaltered, indicating the incorporation of the air blade 140 into the lathe system 100 may not cause any adverse flow conditions for the soot deposition from the burners 114 to the rotating soot blank 130. Additionally, although the flow pattern downstream of the air blade 140 may be altered, the backward flow towards the surface 132 of the soot blank 130 may be minimal, indicating that limited or no contaminant may be brought back up to the surface 132 of the soot blank 130 by the air blade 140. Accordingly, the various embodiments of the air blade 140 described herein may be incorporated into any existing lathe systems, configured with appropriate flowrate and/or flow velocity for the cooling airflow delivered by the air blade 140, to provide additional cooling to the soot blank 130 without adversely affecting the existing deposition process.

### Additional Measures for Mitigating Contaminant Backflow

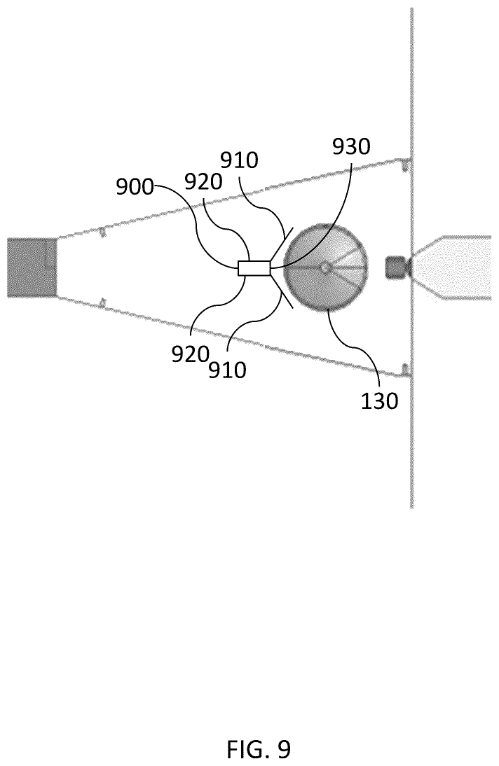

FIG. 9 schemetically illustrates another exemplary embodiment of an air blade 900. Many aspects of the air blade 900 may be similar to or the same as the various embodiments of the air blade 140, 400, 700 described herein. The air blade 900 may differ in that the air blade 900 may further include a pair of baffles 910. In some embodiments, each of the pair of baffles 910 may extend from a side wall 920 or a leading wall 930 of the air blade 900 toward the soot blank 130. The pair of baffles 910 may define a cone or region within the soot blank 130 may be disposed, thereby preventing any contaminants from reaching the soot blank 130 from downsteam of the air blade 900.

### Effective Cooling by Air Blade

### Effective Cooling at Various Cooling Airflow Velocities

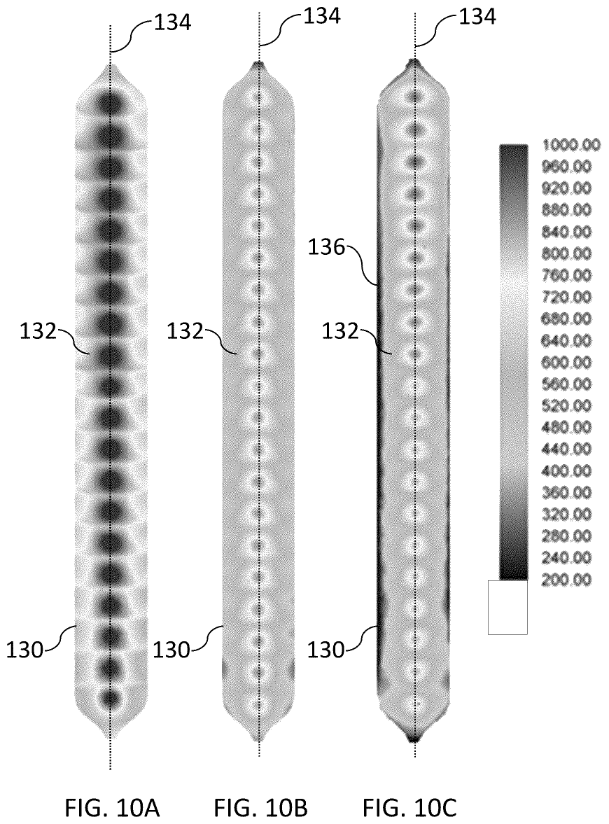

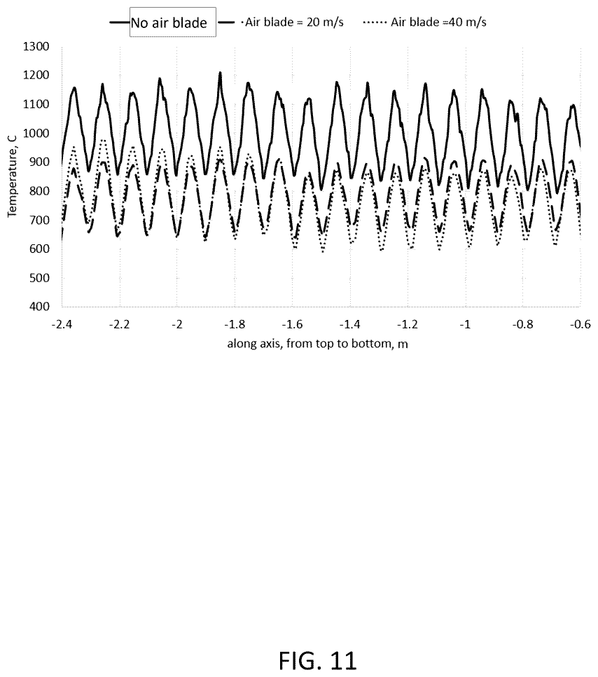

FIGS. 10A, 10B, and 10C show the modeled temperature contours of the leading half of the surface 132 of the rotating soot blank 130 facing the burners 114 using Computational Fluid Dynamics (CFD). FIG. 10A shows the temperature contour of the leading half of the surface 132 of the rotating soot blank 130 facing the burners 114 without implementing the air blade 140 (“Baseline”). FIGS. 10B and 10C show the temperature contours of the leading half of the surface 132 of the rotating soot blank 130 facing the burners 114 with the air blade 140 disposed downstream of the rotating soot blank 130 and providing cooling airflow toward the rotating soot blank 130. For the modeling, each of the rotating soot blank 130 is assumed to have a diameter of 238 mm, and the cooling airflow velocity from the air blade 140 to the rotating soot blank 130 is 20 m/s for the modeling shown in FIGS. 10B and 40 m/s for the modeling shown in FIG. 10C. FIG. 11 further plots the temperature profiles extracted along the middle line 134 (labeled in FIGS. 3 and 10A-10C) of the leading half of the surface 132 of each rotating soot blank 130 facing the burners 114 from FIGS. 10A-10C. The peaks in the plots of FIG. 11 correspond to the locations along the middle line 134 directly facing the burners 114, and the valleys correspond to the midpoint locations between adjacent burners 114.

As shown, the air blade 140 described herein can be highly effective in removing heat from the surface 132 of the rotating soot blank 130, thereby reducing the temperature of the soot blank 130 (e.g., greater than or equal to 200° C. reduction in temperature at both the peak and valley locations) and bowing of the soot blank 130 due to high temperatures. Further, the air blade 140 can be effective when operating at a wide range of airflow velocities as both 20 m/s and 40 m/s airflow velocities are shown to reduce the temperature of the surface 132 facing the burners 114 significantly. Further, when the airflow velocity is increased from 20 m/s to 40 m/s, the temperature of the side portions 136 (labeled in FIG. 10C) of the surface 132 of the rotating soot blank 130 further away from the middle line 134 can be reduced to below 400° C. Such effective cooling achieved by the air blade 140 operating at a wide range of airflow velocities may provide flexibility in the operation window for heat removal from the soot blank 130 and other considerations, such as contaminant flowback prevention.

### Effective Cooling for Varying Soot Blank Diameter

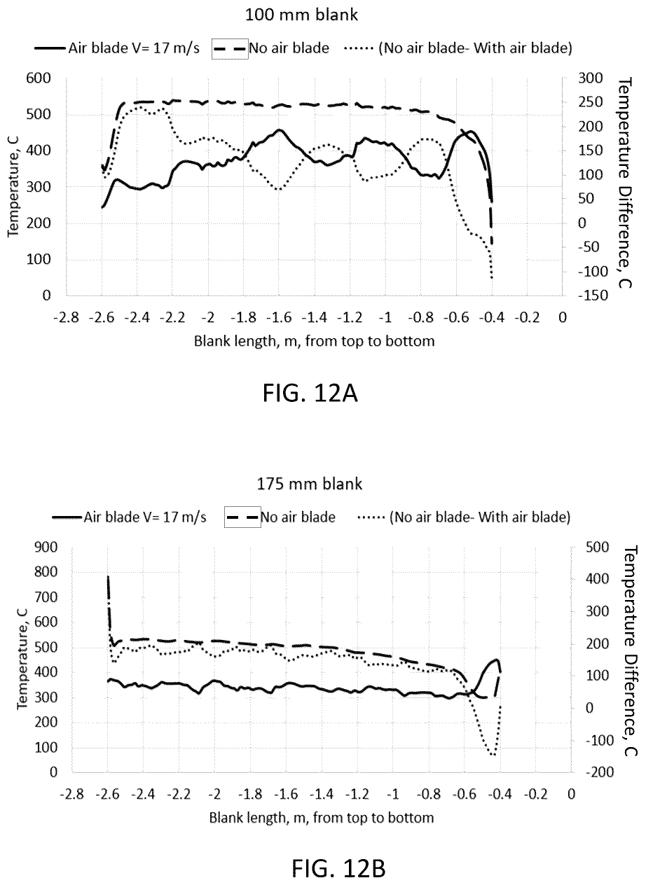

During the deposition process, the diameter of the rotating soot blank 130 increases gradually with time. Numerical modeling is further conducted to explore the effectiveness of the air blade 140 described herein for removing heat continuously as the diameter of the soot blank 130 increases during the deposition process. FIG. 12A shows the temperature profiles along the length of a soot blank 130 having a diameter of 100 mm without cooling by the air blade 140 (dashed line), with cooling by the air blade 140 operating at 17 m/s airflow velocity (solid line), and the difference therebetween (dotted line). FIG. 12B shows the temperature profiles along the length of a soot blank 130 having a diameter of 175 mm without cooling by the air blade 140 (dashed line), with cooling by the air blade 140 operating at 17 m/s airflow velocity (solid line), and the difference therebetween (dotted line). For both the modeling shown in FIGS. 12A and 12B, the distance D_{C} between the leading surface 142 of the air blade 140 facing the rotating soot blank 130 and the centerline 150 of the rotating soot blank 130 is assumed to remain constant. As shown, the air blade 140 described herein can continuously remove heat from the soot blank 130 effectively during the deposition process as the diameter of the soot blank 130 gradually increases. Effective heat removal can be achieved even when the diameter of the soot blank 130 may be relatively small and the surface 132 of the soot blank 130 may be further away from the air blade 140 during the initial growth of the soot blank 130. The soot blank 130 that may be processed using the lathe system 100 described herein with effective cooling by the air blade 140 may have a diameter greater than or equal to (i.e., ≥) 25 mm, ≥50 mm, ≥75 mm, ≥100 mm, ≥120 mm, ≥140 mm, ≥160 mm, ≥180 mm, ≥200 mm, ≥220 mm, ≥240 mm, or greater. In some embodiments, the soot blank 130 may have a diameter greater than or equal to (i.e., ≥) 25 mm and less than or equal to (i.e., ≤) 248 mm—including all sub-ranges or values therebetween.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A lathe system for producing a soot preform, the lathe system comprising:
a housing configured to receive therein a rotating soot blank;
an air intake;
an exhaust;
an airflow pathway through the housing from the air intake to the exhaust; and
an air blade disposed downstream of the rotating soot blank along the airflow pathway and configured to deliver a cooling airflow toward a surface of the rotating soot blank.

2. The lathe system according to claim 1, further comprising at least one combustion burner disposed upstream of the rotating soot blank along the airflow pathway.

3. The lathe system according to claim 1, wherein the air blade comprises a slot configured to deliver the cooling airflow toward the surface of the rotating soot blank.

4. The lathe system according to claim 3, wherein the slot includes a length corresponding to a length of the rotating soot blank.

5. The lathe system according to claim 4, wherein a ratio of the length of the slot to a length of the air blade is greater than or equal to 0.5 and less than or equal to 0.99.

6. The lathe system according to claim 4, wherein the length of the slot is greater than or equal to 1.5 m and less than or equal to 3 m.

7. The lathe system according to claim 3, wherein the slot includes a width greater than or equal to 0.05 mm and less than or equal to 1.5 mm.

8. The lathe system according to claim 1, wherein the air blade comprises a plurality of nozzles configured to deliver the cooling airflow toward the surface of the rotating soot blank.

9. The lathe system according to claim 8, wherein an opening of at least one nozzle of the plurality of nozzles includes a diameter that is greater than or equal to 1 mm and less than or equal to 20 mm.

10. The lathe system according to claim 8, wherein a spacing between two adjacent nozzles of the plurality of nozzles is greater than or equal to 2 mm and less than or equal to 100 mm.

11. The lathe system according to claim 10, wherein a ratio of the spacing between the two adjacent nozzles to the diameter of the opening of the at least one nozzle is greater than or equal to 2:1 and less than or equal to 5:1.

12. The lathe system according to claim 8, wherein a number of the plurality of nozzles is greater than or equal to a number of the at least one combustion burner configured for depositing silica-containing soot onto the surface of the rotating soot blank.

13. The lathe system according to claim 1, further satisfying at least one of the following:
a distance between a leading surface of the air blade facing the rotating soot blank and a centerline of the rotating soot blank is greater than or equal to 185 mm and less than or equal to 370 mm; or
a distance between a leading surface of the air blade and the surface of the rotating soot blank is greater than or equal to 60 mm and less than or equal to 240 mm.

14. The lathe system according to claim 1, wherein the air blade is configured to move relative to the rotating soot blank such that at least one of the distance between the leading surface of the air blade facing the rotating soot blank and the centerline of the rotating soot blank or the distance between the leading surface of the air blade and the surface of the rotating soot blank remains consistent during the deposition of the soot on the surface of the rotating soot blank.

15. The lathe system according to claim 1, wherein the air blade includes a width or a diameter that is greater than or equal to 25 mm and less than or equal to 75 mm.

16. The lathe system according to claim 1, wherein the air blade further comprises at least one baffle extending from a wall of the air blade and configured for shielding the rotating soot blank from backflown contaminant.

17. A method of producing a soot preform, wherein the method comprising:
depositing soot on a surface of a rotating soot blank using at least one combustion burner disposed upstream of the rotating soot blank; and
directing a cooling airflow toward the surface of the rotating soot blank using an air blade disposed downstream of the rotating soot blank.

18. The method according to claim 17, wherein the at least one combustion burner and the air blade are disposed on opposite sides of the rotating soot blank.

19. The method according to claim 17, wherein the air blade comprises a slot or a plurality of nozzles configured to deliver the cooling airflow toward the surface of the rotating soot blank.

20. The method according to claim 17, wherein the air blade further comprises at least one baffle extending from a wall of the air blade and configured for shielding the rotating soot blank from backflown contaminant.
